(19) United States
(12) Patent Application Publication
(10) Pub. No.: US 2008/0292162 A1
(43) Pub. Date: Nov. 27, 2008

(54) Method and System for Generating a Collage to Summarize a Medical Dataset

(76) Inventors: David Thomas Gering, Waukesha, WI (US); Elizabeth Nicole Larson, Waukesha, WI (US)

Correspondence Address: MCANDREWS HELD & MALLOY, LTD, 500 WEST MADISON STREET, SUITE 3400, CHICAGO, IL, 60661, US

(21) Appl. No.: 11/752,681

(22) Filed: May 23, 2007

(51) Int. Cl. G06K 9/00

(52) U.S. Cl. 382/131

(57) ABSTRACT

Certain aspects of a method and system for generating a collage of images or videos to summarize a medical dataset are disclosed. Aspects of one method may include segmenting medical images based on a type of tissue. A portion of each of the segmented medical images may be selected based on one or more selection criteria by fitting a bounding box encompassing each selected portion. A collage of images may be generated based on the selected portion of each of the segmented medical images. The generated collage of images may be stored in an image storage repository.

### CROSS-REFERENCE TO RELATED APPLICATIONS

[Not applicable]

### FEDERALLY SPONSORED RESEARCH OR DEVELOPMENT

[Not applicable]

### MICROFICHE/COPYRIGHT REFERENCE

[Not applicable]

### FIELD OF THE INVENTION

Certain embodiments of the invention relate to generating a collage. More specifically, certain embodiments of the invention relate to a method and system for generating a collage of images or videos to summarize a medical dataset.

### BACKGROUND OF THE INVENTION

Documents and data representing a patient's medical record may be generated and archived on a variety of systems over the course of diagnosis and treatment. A number of imaging and clinical activities may benefit from a coordinated method for sharing, locating and accessing relevant imaging related documents. Images, diagnostic reports, and evidence documents derived from the processing of images may represent important components of a patient's medical record. These imaging documents may be managed and archived on a variety of imaging information systems such as a radiology information system (RIS) and a picture archiving and communication system (PACS) over the course of diagnosis and treatment.

For example, for a particular patient, some of this imaging information may be produced in departments associated with one or more in-patient facilities, where the patient may have been hospitalized, as well as independent imaging centers. A number of healthcare delivery professionals, for example, referring physicians, radiologists, surgeons, and oncologists may benefit from a coordinated method for locating and accessing relevant imaging information. The creation and subsequent usage of these documents may span several care delivery organizations and may be performed separately over different time periods.

As medical technology becomes more sophisticated, clinical analysis and imaging related information may also become more sophisticated. Increasing amounts of data are generated and archived electronically. With the advent of clinical information systems, a patient's history may be available at a touch of a button. While accessibility of information is advantageous, time is a scarce commodity in a clinical setting. To realize the full benefit of medical technological growth, there is a need for clinical information to be organized and standardized.

The problem of data overload has continued to grow over the years, and there is a need to develop a solution to allow computers to help focus radiologists towards the most relevant data first. Diagnostic imaging scanners may soon be capable of generating an order of magnitude more data than what has been acquired recently. For example, some institutions are discarding computer tomography (CT) slices to avoid overloading their PACS. There is a need to develop compression techniques, or some new alternative, to relieve the strain on system resources.

There has been an increase in utilization of personal digital assistant (PDA)-like handheld devices in radiology, but massive datasets need to be winnowed down for easy navigation and viewing on the small displays of handheld devices. There is a need to develop a system that would be capable of selecting portions of a particular dataset to display medical images and video data.

Based on current trends, in the future, mobile devices may enable doctors to electronically store their logbooks in an accurate and organized fashion and may be able to send and receive patient information, including images using RIS/PACS. The mobile devices may also be enable doctors to collaborate vocally with multiple specialists at the same time and enable compressing a physician's clinical experience into the palm of his/her hand. Each dataset may be first processed to form a record comprising a set of image icons, waveforms, and parameters. The records for a particular physician may then be sorted and displayed in order of relevance to the case at hand. There is a need for a system that can be used on a handheld device, or a full-sized workstation to generate an image that facilitates easy understanding of, and interaction with, a massive dataset based on intelligent image analysis and display.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for generating a collage of images or videos to summarize a medical dataset is disclosed, substantially as shown in and/or described in connection with at least one of the figures, and as set forth more completely in the claims.

Certain embodiments provide a method for segmenting medical images based on a type of tissue. The method includes selecting a portion of each of the segmented medical images based on one or more selection criteria by fitting a bounding box encompassing each selected portion. The method also includes generating a collage of images based on the selected portion of each of the segmented medical images. The method further includes storing the generated collage of images in an image storage repository.

Certain embodiments provide a system for processing imaging information. The system may comprise a processor for segmenting medical images based on a type of tissue. The processor may be enabled to select a portion of each of the segmented medical images based on one or more selection criteria by fitting a bounding box encompassing each selected portion. The processor may also be enabled to generate a collage of images based on the selected portion of each of the segmented medical images. An image storage repository may store the generated collage of images.

Certain embodiments provide a method for segmenting medical imaging data based on a type of tissue, for example, an anatomical tissue or a functional tissue. The method includes selecting a portion of each of the segmented medical imaging data. The method further includes generating a collage based on the selected portion of each of the segmented imaging data. The method also includes storing the generated collage in an image storage repository.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an exemplary picture archiving and communication system (PACS), in accordance with an embodiment of the invention.

FIG. 2 illustrates a segmented medical image, for example, an articular cartilage of a knee tissue that may be utilized in connection with an embodiment of the invention.

FIG. 3 illustrates a bounding box around a selected portion of the segmented medical image, for example, the scanned articular cartilage image of a knee tissue, in accordance with an embodiment of the invention.

FIG. 4 is a diagram illustrating a generated collage of images or videos, in accordance with an embodiment of the invention.

FIG. 5 is a diagram illustrating a selected image from the generated collage of images or videos, in accordance with an embodiment of the invention.

FIG. 6 is a flowchart illustrating exemplary steps for generating a collage of images or videos to summarize a medical dataset, in accordance with an embodiment of the invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

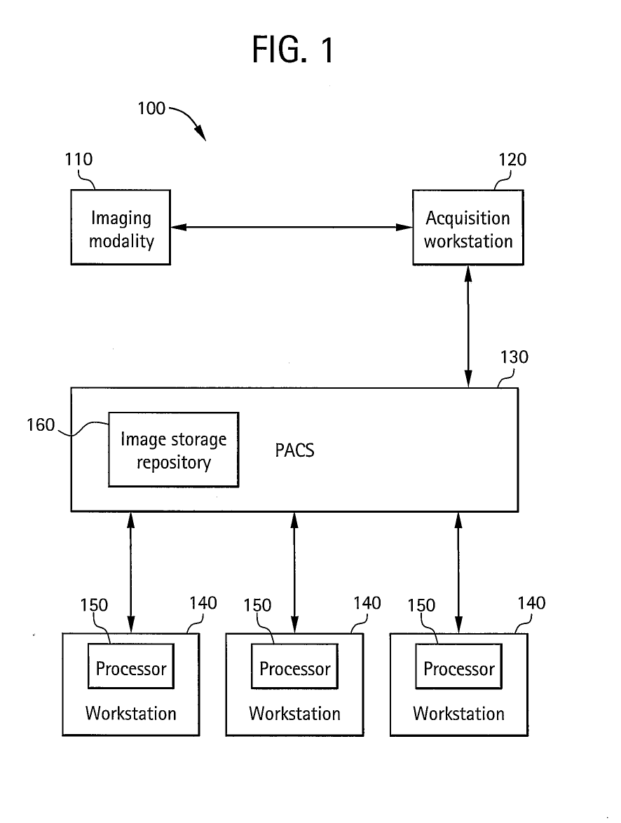

FIG. 1 illustrates an exemplary picture archiving and communication system (PACS), in accordance with an embodiment of the present invention. Referring to FIG. 1, there is shown a PACS system 100. The PACS system 100 may include one or more imaging modalities 110, acquisition workstations 120, PACS 130 and workstations 140. The PACS 130 may comprise an image storage repository 160. The plurality of workstations 140 may comprise one or more processors 150 and may not be limited to the embodiment of PACS system 100 illustrated in FIG. 1. The components of the PACS system 100 may communicate via wired and/or wireless communication, for example, and may be separate systems and/or integrated to varying degrees, for example.

In operation, the imaging modality 110 may be enabled to obtain one or more images or videos of a patient's anatomy. The imaging modality 110 may include any device capable of capturing an image or video of a patient's anatomy such as a medical diagnostic imaging device. For example, the imaging modality 110 may include an X-ray imager, ultrasound scanner, magnetic resonance imager, or the like. An imaging data representative of the image(s) may be communicated between the imaging modality 110 and the acquisition workstation 120. The imaging data may be communicated electronically over a wired or wireless connection, for example.

In an embodiment, the acquisition workstation 120 may apply one or more preprocessing functions, for example, to the imaging data in order to prepare the image for viewing on a workstation 140. For example, the acquisition workstation 120 may convert raw imaging data into a DICOM standard format or attach a DICOM header. The preprocessing functions may be characterized as modality-specific enhancements, for example, contrast or frequency compensation functions specific to a particular X-ray imaging device may be applied at the beginning of an imaging and display workflow. The preprocessing functions may differ from processing functions applied to imaging data in that the processing functions may not be modality specific but may be applied at the end of the imaging and display workflow, for example, at a display workstation 140. The imaging data may then be communicated between the acquisition workstation 120 and the PACS 130. The imaging data may be communicated electronically over a wired or wireless connection, for example.

In certain embodiments, the PACS 130 may include computer-readable storage media suitable for storing the imaging data for later retrieval and viewing at a workstation 140, for example, a personal computer, a PDA, or a laptop. The PACS 130 may also include one or more software applications for additional processing and/or preprocessing of the imaging data by one or more workstations 140.

In certain embodiments, one or more workstations 140, for example, a personal computer, a PDA, and a laptop may be capable of or may be configured to communicate with the PACS 130. The workstations 140 may include a general purpose processing circuit or a processor 150, a PACS 130 interface, a software memory, and/or an image display monitor, for example. The PACS 130 interface may be implemented as a network card connecting to a TCP/IP based network, but may also be implemented as a parallel port interface, for example.

In certain embodiments, the processor 150 may be enabled to segment medical images based on a type of tissue, for example, a knee tissue, a cartilage tissue or a brain tissue. The processor 150 may be enabled to select a portion of each of the segmented medical images based on one or more selection criteria by fitting a bounding box encompassing each selected portion. The processor 150 may also be enabled to generate a collage of images based on the selected portion of each of the segmented medical images. The image storage repository 160 may be enabled to store the generated collage of images in a long-term storage, for example. In an embodiment, the image storage repository 160 may comprise a set of local hard disk drives. In another embodiment, the image storage repository 160 may comprise online disk storage such as a redundant array of inexpensive disks (RAID) array.

In certain embodiments, the workstations 140 may also be capable of or may be configured to apply processing functions to imaging data. For example, a user may desire to apply processing functions to enhance features within an image representative of the imaging data. The processing functions may therefore adjust an image of a patient's anatomy in order to ease a user's diagnosis of the image. Such processing functions may include any software-based application that may alter a visual appearance or representation of imaging data. For example, a processing function may include any one or more of flipping an image, zooming in on an image, panning across an image, altering a window and/or level in a grayscale representation of the imaging data, and altering a contrast and/or brightness of an image.

In certain embodiments, the workstations 140 may retrieve or receive imaging data from the PACS 130 for display to one or more users. For example, a workstation 140 may retrieve or receive imaging data representative of a computed radiography image of a patient's chest. A radiologist may then examine the image as displayed on a workstation 140 for any objects of interest, for example, tumors or lesions.

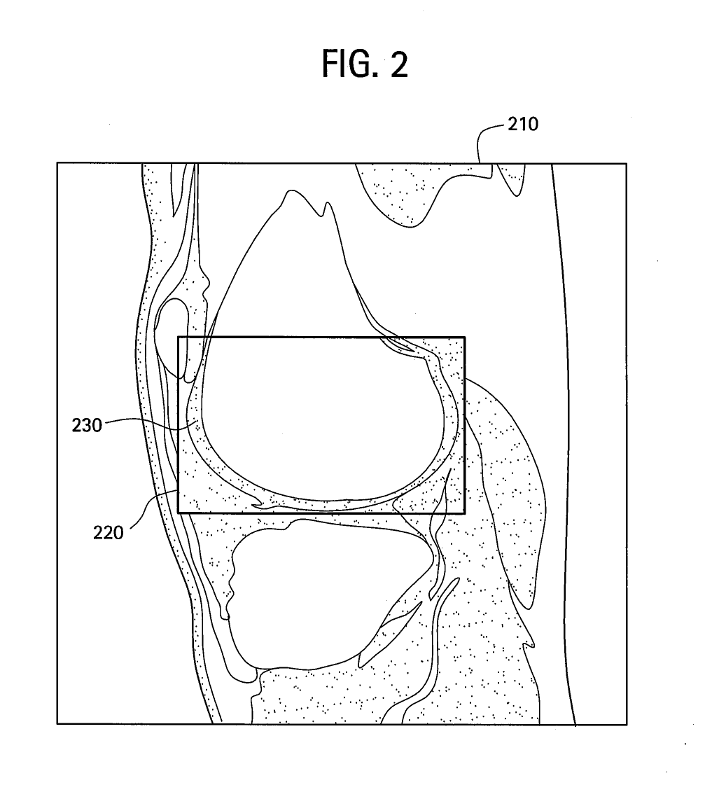

FIG. 2 illustrates a segmented medical image, for example, an articular cartilage of a knee tissue that may be utilized in connection with an embodiment of the invention. Referring to FIG. 2, there is shown a segmented medical image 210 illustrating an articular cartilage of a knee scan. The segmented medical image 210 comprises a bounding box 220 and a selected portion 230 of the segmented medical image 210.

The segmented medical image 210 may represent a portion of a slice of knee tissue, for example. The segmented medical image 210 may be a medical image, for example, X-ray images, magnetic reasonance imaging (MRI) data, computer tomography (CT) imaging data, ultrasound imaging data, positron emission tomography (PET) data and other medical imaging data. Notwithstanding, the segmented medical image 210 may be a collection of images at different time instants or a video of imaging data, for example, a video of operation of a heart. The bounding box 220 may be fit encompassing a selected portion 230 of the segmented medical image 210 based on one or more selection criteria or a user's parameters. For example, a user may be enabled to select a portion of a slice of the segmented medical image 210 based on the type of tissue. The bounding box 220 may be positioned to encompass the selected portion 230 of the segmented medical image 210. The bounding box 220 may be of a suitable shape to encompass the selected portion 230. For example, the bounding box 220 may be rectangular, square, circular, elliptical or any other irregular shape to encompass the selected portion 230. The segmented medical image 210 may be a knee tissue, a brain tissue or any other suitable tissue, for example. For example, the segmented medical image 210 may be a MRI scan of a brain. The selected portion 230 may be a brain tumor and a bounding box 220 of suitable shape may be fit to encompass the brain tumor.

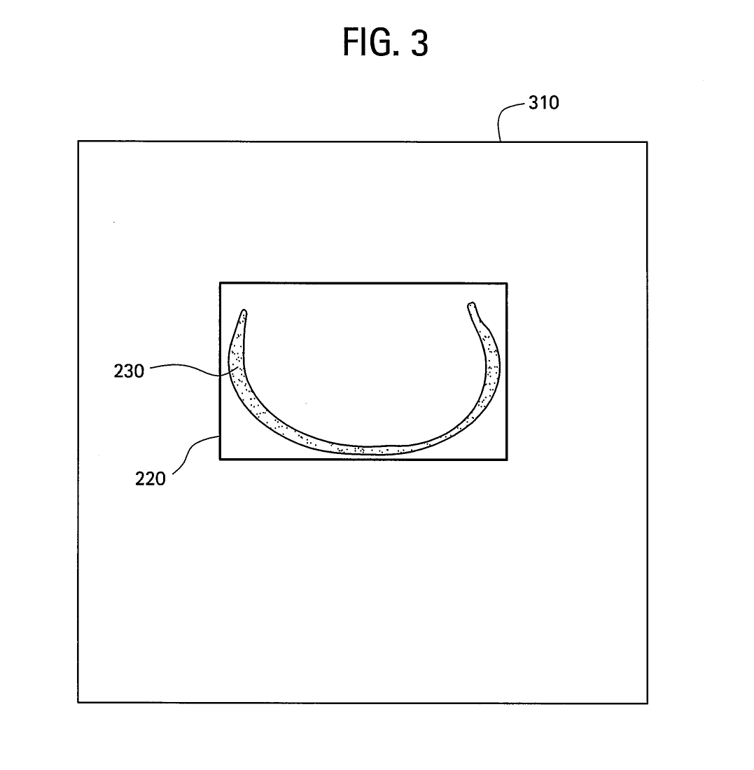

FIG. 3 illustrates a bounding box around a selected portion of the segmented medical image, for example, the scanned articular cartilage image of a knee tissue, in accordance with an embodiment of the invention. Referring to FIG. 3, there is shown a segmented medical image 310 illustrating a selected portion 230 of the scanned segmented medical image 310, for example, an articular cartilage image of a knee tissue. The segmented medical image 310 comprises a bounding box 220 and a selected portion 230 substantially as described in FIG. 2. The bounding box 220 may be fit encompassing a selected portion 230 based on one or more selection criteria or a user's parameters. The bounding box 220 may be of a suitable shape to encompass the selected portion 230.

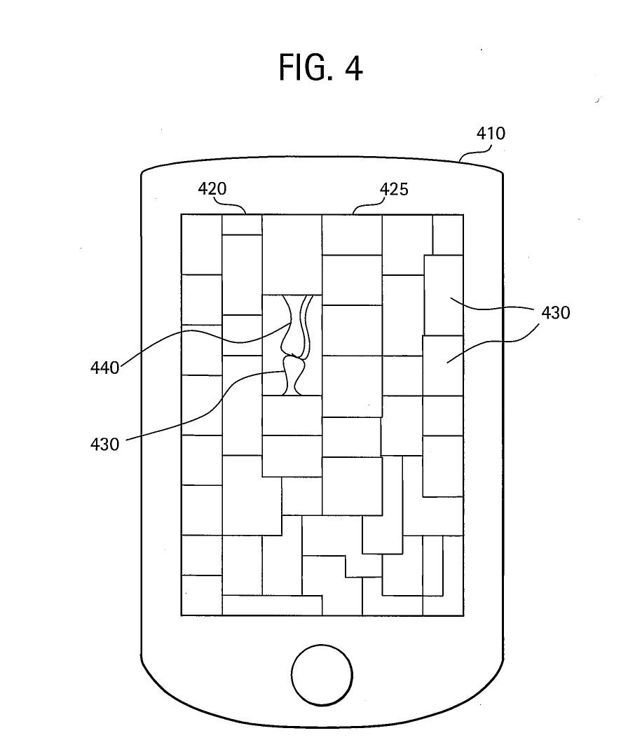

FIG. 4 is a diagram illustrating a generated collage of images or videos, in accordance with an embodiment of the invention. Referring to FIG. 4, there is shown a workstation 410. The workstation 410 may be, for example, a personal computer, a PDA, or a laptop. The workstation 410 may comprise a display 420. The display 420 may be enabled to display a collage of images 425. The collage of images 425 may comprise a plurality of selected portions 430 of segmented medical images 210. In certain embodiments, the selected portion 430 of the segmented medical images 210 may comprise a slice 440 of a particular tissue, for example, a knee tissue, or a brain tissue. Notwithstanding, the collage of images 425 may not be limited to images but may comprise videos and other medical imaging data.

Certain embodiments provide a method for segmenting medical images 210 based on a type of tissue, for example, a knee tissue, a cardiac tissue or a brain tissue. A selected portion 430 of each of the segmented medical images 210 may be selected based on one or more selection criteria by fitting a bounding box 220 encompassing each selected portion 430. The collage of images 425 may be generated based on the selected portion 430 of each of the segmented medical images 210. The generated collage of images 425 may be stored in an image storage repository 160. Notwithstanding, the selected portion 430 may not be limited to images but may comprise videos and other medical imaging data.

The generated collage of images 425 may be displayed on a workstation 140, for example, a laptop, PDA, or a personal computer. The workstation 140 may be connected to a PACS 130. The selected portion 430 of one or more of the segmented medical images 210 may be displayed on the workstation 140. The selected portion 430 of one or more of the segmented medical images 210 displayed on the workstation 140 may be minimized or expanded based on a user's preferences. In certain embodiments, one or more of: a two-dimensional view and a three-dimensional view of the selected portion 430 of one or more of the segmented medical images 210 may be displayed on the workstation 140. In another embodiment, the user may be enabled to view a selected portion 430 of one or more of the segmented medical images 210 in either a two-dimensional view or a three-dimensional view, for example.

In certain embodiments, the selected portion 430 of one or more of the segmented medical images 210 over a period of time may be displayed on the workstation 140. In certain embodiments, the generated collage of images 425 may be transmitted first to the workstation 140, if a network bandwidth is lower than a particular threshold. In another embodiment, the complete dataset of each of the selected portions 430 of one or more of the segmented medical images 210 may be transmitted to the workstation 140 while the user is interacting with the collage of images 425. In certain embodiments, a particular selected portion 430 may be given a higher priority for transmission, if the user selects to view the particular selected portion 430 on the display 420. The segmented medical images 210 may comprises one or more of: X-ray images, magnetic reasonance imaging data, ultrasound imaging data, computer tomography imaging data, positron emission tomography (PET) data and other medical imaging data.

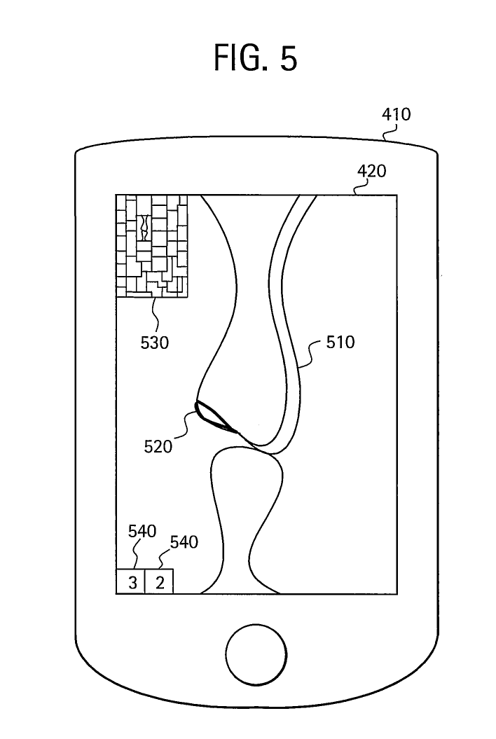

FIG. 5 is a diagram illustrating a selected image from the generated collage of images or videos, in accordance with an embodiment of the invention. Referring to FIG. 5, there is shown a workstation 410. The workstation 410 may be, for example, a personal computer, a PDA, or a laptop. The workstation 410 may comprise a display 420. The display 420 may be enabled to display a collage of images 530. The collage of images may comprise a plurality of selected portions 430 of segmented medical images 210. In certain embodiments, the selected portion 430 of the segmented medical images 210 may comprise a slice 510 of a particular tissue, for example, a knee tissue, or a brain tissue. In certain embodiments, the slice 510 of a particular tissue, for example, a knee tissue may comprise a lesion 520.

In certain embodiments, the generated collage of images 530 may be displayed on a workstation 140, for example, a laptop, PDA, or a personal computer. The workstation 140 may be connected to a PACS 130. The selected portion 430 of one or more of the segmented medical images 210 may be displayed on the workstation 140. The selected portion 430 of one or more of the segmented medical images 210 displayed on the workstation 140 may be minimized or expanded based on a user's preferences. For example, the minimized selected portions 430 of one or more of the segmented medical images 210 may be displayed as one or more tabs 540. In accordance with an embodiment, the user may be enabled to click on a particular tab 540 to expand and display the selected portion 430 of one or more of the segmented medical images 210 on the display 420. In certain embodiments, a user may be enabled to alternate between one or more tabs 540 to view one or more selected portions 430 of one or more of the segmented medical images 210 on the display 420. In certain embodiments, the user may be enabled to zoom in or zoom out a selected portion 430 of one or more of the segmented medical images 210 on the display 420. In certain embodiments, when the user clicks on a selected portion 430, the selected portion 430 may be loaded and displayed on the display 420, and the collage of images 530 may be minimized or may be displayed at a lower resolution on the display 430 as illustrated in FIG. 5.

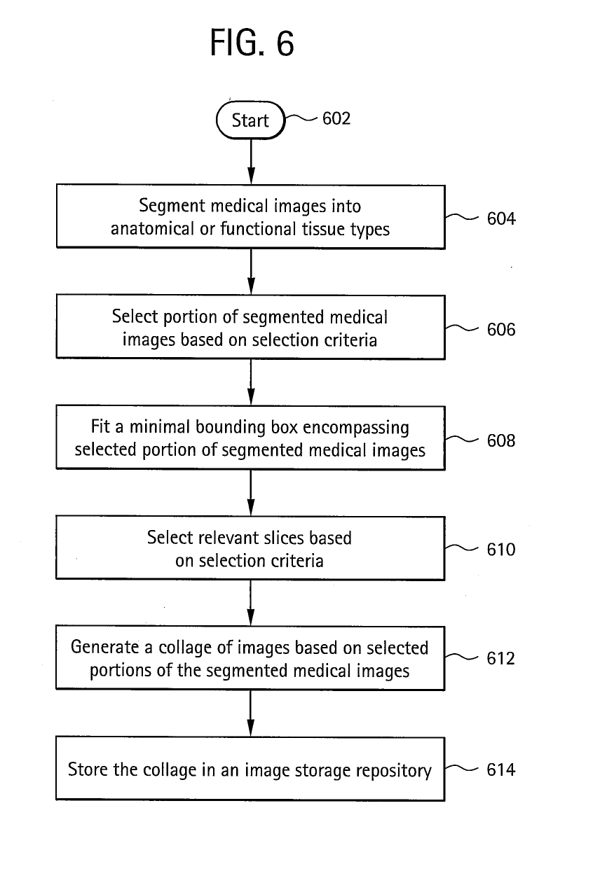

FIG. 6 is a flowchart illustrating exemplary steps for generating a collage of images to summarize a medical dataset, in accordance with an embodiment of the invention. Referring to FIG. 6, exemplary steps may begin at step 602. In step 604, a plurality of medical images may be segmented based on a type of tissue, for example, anatomical tissues, functional tissues. In step 606, a selected portion of each of the segmented medical images may be selected based on one or more selection criteria. In step 608, a bounding box may be fit encompassing each selected portion of the segmented medical images. In step 610, a plurality of slices of the selected portions of the segmented medical images may be selected based on one or more selection criteria. For example, a lesion in a knee tissue or a tumor in a brain tissue may be selected. In step 612, a collage of images may be generated based on the selected portion of each of the segmented medical images. In step 614, the generated collage of images may be stored in an image storage repository.

One or more of the steps of the method for generating a collage of images or videos to summarize a medical dataset may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Another embodiment of the invention may provide a machine-readable storage, having stored thereon, a computer program having at least one code section executable by a machine, thereby causing the machine to perform the steps as described above for generating a collage of images to summarize a medical dataset.

In accordance with an embodiment of the invention, a method for generating a collage of images to summarize a medical dataset may comprise segmenting medical images 210 based on a type of tissue, for example, an anatomical tissue or a functional tissue. A functional tissue may include computation of parametric maps, such as relative Cerebral Blood Volume (rCBV), for example. The tissues may be knee tissues, cardiac tissues or brain tissues, for example. A selected portion 430 of each of the segmented medical images 210 may be selected based on one or more selection criteria by fitting a bounding box 220 encompassing each selected portion 430. The selection criteria may depend on a modality, a particular body part, or a type of tissue, for example, an anatomical tissue or a functional tissue. The collage of images 425 may be generated based on the selected portion 430 of each of the segmented medical images 210. The generated collage of images 425 may be stored in an image storage repository 160.

In accordance with another embodiment of the invention, a method for generating a collage of images or videos to summarize a medical dataset may comprise segmenting medical segmenting medical imaging data 210 based on a type of tissue, for example, an anatomical tissue or a functional tissue. A functional tissue may include computation of parametric maps, such as relative Cerebral Blood Volume (rCBV), for example. The method includes selecting a portion 430 of each of the segmented medical imaging data 210, for example, cardiac cine loops, or 3-D renderings of medical images from different viewing angles. The method further includes generating a collage 425 based on the selected portion 430 of each of the segmented imaging data 210. The method also includes storing the generated collage 425 in an image storage repository 160. The segmented medical imaging data 210 may comprise one or more of: two-dimensional medical imaging data, such as medical images, three-dimensional medical imaging data, such as 3-D renderings of medical images and four-dimensional medical imaging data, such as videos.

In accordance with an embodiment of the invention, a system for generating a collage of images to summarize a medical dataset may comprise a processor 150 that enables segmentation of medical images 210 based on a type of tissue, for example, anatomical tissues or functional tissues. The processor 150 may be enabled to select a portion 430 of each of the segmented medical images 210 by fitting a bounding box 220 encompassing the selected portion 430 of each of the segmented medical images 210. The processor 150 may be enabled to generate a collage of images 425 based on the selected portion 430 of each of the segmented medical images 210. The image storage repository 160 may be enabled to store the generated collage of images 425.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for processing imaging information, the method comprising:
segmenting medical images based on a type of tissue;
selecting a portion of each of said segmented medical images; and
generating a collage of images based on said selected portion of each of said segmented medical images.

2. The method according to claim 1, further comprising storing said generated collage of images in an image storage repository.

3. The method according to claim 1, further comprising selecting said portion of each of said segmented medical images based on one or more selection criteria.

4. The method according to claim 3, further comprising selecting one or more slices of said segmented medical images based on said one or more selection criteria.

5. The method according to claim 1, wherein said type of tissue comprises one or more of: an anatomical tissue and a functional tissue.

6. The method according to claim 1, further comprising fitting a bounding box encompassing said selected portion of each of said segmented medical images.

7. The method according to claim 1, further comprising displaying said generated collage of images on a workstation.

8. The method according to claim 7, wherein said workstation comprises one or more of: a personal digital assistant (PDA), a personal computer, and a laptop.

9. The method according to claim 7, further comprising displaying said selected portion of one or more of said segmented medical images on said workstation.

10. The method according to claim 7, further comprising minimizing said selected portion of one or more of said segmented medical images displayed on said workstation.

11. The method according to claim 7, further comprising displaying one or more of: a two-dimensional view and a three-dimensional view of said selected portion of one or more of said segmented medical images displayed on said workstation.

12. The method according to claim 7, further comprising if a network bandwidth is lower than a particular threshold, transmitting said generated collage of images to said workstation.

13. The method according to claim 12, further comprising if said network bandwidth is lower than said particular threshold, transmitting a dataset of each of said selected portion of one or more of said segmented medical images to said workstation.

14. The method according to claim 1, further comprising displaying said selected portion of one or more of said segmented medical images over a period of time.

15. The method according to claim 1, wherein said segmented medical images comprises one or more of: X-ray images, magnetic reasonance imaging data, ultrasound imaging data, computer tomography imaging data, positron emission tomography data and medical imaging data.

16. A system for processing imaging information, said system comprising:
a processor that enables segmentation of medical images based on a type of tissue;
said processor enables selection of a portion of each of said segmented medical images; and
said processor enables generation of a collage of images based on said selected portion of each of said segmented medical images.

17. The system according to claim 16, further comprising an image storage repository for storing said generated collage of images.

18. The system according to claim 16, further comprising a workstation comprising said processor.

19. A method for processing imaging information, the method comprising:
segmenting medical imaging data based on a type of tissue;
selecting a portion of each of said segmented medical imaging data; and
generating a collage based on said selected portion of each of said segmented medical imaging data.

20. The method according to claim 19, further comprising storing said generated collage in an image storage repository.

21. The method according to claim 19, wherein said medical imaging data comprises one or more of: two-dimensional medical imaging data, three-dimensional medical imaging data and four-dimensional medical imaging data.

22. A machine-readable storage having stored thereon, a computer program having at least one code section for processing imaging information, the at least one code section being executable by a machine for causing the machine to perform steps comprising:
segmenting medical images based on a type of tissue;
selecting a portion of each of said segmented medical images; and
generating a collage of images based on said selected portion of each of said segmented medical images.
